(19) United States
(12) Patent Application Publication
(10) Pub. No.: US 2025/0377268 A1
(43) Pub. Date: Dec. 11, 2025

(54) LABORATORY MILL

(71) Applicant: FRITSCH GMBH, Idar-Oberstein (DE)

(72) Inventors: Marco Bauer, Merxheim (DE); Markus Bund, Marpingen (DE); Eugen Kompanez, Baumholder (DE); Juri Dinges, Idar-Oberstein (DE)

(21) Appl. No.: 18/877,009

(22) PCT Filed: Jun. 13, 2023
(86) PCT No.: PCT/EP2023/065763

§ 371 Date: Dec. 19, 2024

(30) Foreign Application Priority Data
Jun. 20, 2022 (DE) 10 2022 115 334.7

(51) Int. Cl. G01N 1/28

(52) U.S. Cl. CPC G01N 1/286; G01N 2001/2866

(57) ABSTRACT

A laboratory mill for comminuting grist, is provided. A device housing has a grinder housing and/or a grinding vessel, and a grinding space therein. A grinder can be arranged in the grinding space, to comminute grist, and the grinder housing or the grinding vessel comprises a user access opening closeable by a grinder housing door or a safety cover having an open and a closed state. A user has access to the grinder through the user access opening, in the open state of the grinder housing door or of the safety cover. A grinder drive drives the grinder. The grinder housing door or the safety cover comprises a closure element, lockable in the closed state. The laboratory mill comprises a mechanical grinder drive locking mechanism.

### TECHNICAL FIELD

The present disclosure relates to a laboratory mill, in particular a cutting mill, a cross beater mill, a disk mill, a knife mill or a beater or impact mill on a laboratory scale, which comprise a grinder in which grist or material to be ground is comminuted e.g. in a gap between a grinder rotor and one or more stationary counter-elements, between two disks or by a rotor blade or beater or impact rotor.

### Background

Cutting mills comminute grist between a rotating cutting rotor having one or more rotor blades that extend substantially axially and one or more stationary counter-blades that also extend substantially axially according to the scissor principle. Such laboratory cutting mills are in particular suitable for comminuting tough or fibrous samples, e.g. biological samples such as straw but e.g. also plastics films, to name just some examples. Examples for current laboratory cutting mills are e.g. the PULVERISETTE® 19 and the PULVERISETTE® 15 by the applicant, to the basic construction of which reference is hereby made. Corresponding product descriptions of the PULVERISETTE® 19 and the PULVERISETTE® 15 can be found e.g. at www.fritsch.de.

In the case of these cutting mills on a laboratory scale, typically more or less trickleable or pourable bulk material is filled into the grinding chamber e.g. via a filling funnel, in which chamber the cutting rotor rotates about a horizontal axis. The cutting rotor can have different geometries, e.g. with straight blades or what are known as V-blades. The latter exhibit twist and thereby achieve a good cutting action, above all in the case of comminution of tough-elastic materials and films.

Typically a sieve, e.g. a sieve cassette, is located below the cutting rotor, through which sieve the sample material, which has already been sufficiently comminuted, can trickle in order to be collected in a collecting vessel located therebelow. With regard to further structural details of a cutting mill, which are essentially known to a person skilled in the art in this field, reference is made to the product descriptions relating to the cutting mills PULVERISETTE® 19 and PULVERISETTE® 15 by the applicant, which, at the time of the application and the publication thereof, can be downloaded at www.fritsch.de, and which are hereby incorporated by reference with respect to the fundamental construction of a cutting mill of this kind. Furthermore, the applications DE 196 01 594, DE 10 2018 113 751 A1, WO 2020/200759 A1 and DE 10 2019 133 437 A1 describe such cutting mills and are hereby also incorporated by reference.

There may be a potential risk of injury for the user of a cutting mill, in the grinding space between the rotating cutting rotor and the stationary counter-blades. Similar possible risks can also result in the case of cross beater mills (cf. PULVERISETTE® 16, www.fritsch.de) or disk mills (cf. PULVERISETTE® 13, www.fritsch.de), the product descriptions of which are hereby also incorporated by reference. These laboratory mills also comprise a rotor-grinder, in which grist is comminuted between a grinder rotor and stationary counter-elements of the rotor-grinder. Similar possible risks can also result in the case of knife mills, in which a rotor blade rotates about a vertical axis, in a grinding vessel (cf. PULVERISETTE® 11, www.fritsch.de) or in the case of beater or impact mills, sometimes also referred to as (variable) speed rotor mills, in which a beater or impact rotor rotates in an annular sieve about a vertical axis in a grinding vessel configured as a collecting vessel (cf. PULVERISETTE® 14, www.fritsch.de), the product descriptions of which are hereby also incorporated by reference.

In the case of such grinders, it is necessary to prevent the user from being able to access the grinder, in particular the region of the grinder rotor or between the grinder rotor and the stationary counter-elements, e.g. with a finger, during the grinding process, and it is necessary to reliably prevent the grinder rotor from starting up in the event of an error, e.g. in the event of a software error, when the mill is open.

With reference again to the example of a cutting mill, the grinding chamber is typically closed by a door at the end face. The door can e.g. be monitored electronically and locked electronically in order to protect the user. Such mills can e.g. comprise an electric tumbler in order that the door cannot be opened as long as the mill is in operation. Knife mills typically comprise a correspondingly secured cover, e.g. in the form of a device hood, which prevents access, in the closed state, to the interior of the grinding vessel comprising the rotor blade arranged therein.

On account of the safety requirements, such electrical or electronic safety systems require dual-channel or redundant circuits, as well as various redundant standstill monitors, in order to prevent remaining dangers in the case of electrical malfunctions.

Mills can also comprise a motor brake, which is e.g. flanged to the rear of the motor shaft, in order to be able to brake the motor shaft more quickly. For safety reasons, the motor brake brakes in the currentless state, and in order to operate the mill the brake jaws are actively ventilated by the motor shaft by energization. However, motor brakes are subject to significant wear and typically do not offer any monitoring as to whether they are functioning correctly. Furthermore, such motor brakes constantly require electrical energy, during operation, in order to remain ventilated. Moreover, a brake is typically not a safety-focused component in the sense of DIN EN ISO 12100, and therefore further electrical safety measures are required.

DIN EN ISO 12100—“Safety of machinery” contains general principles for design for machinery, as well as for risk assessment and risk reduction, and is inter alia relevant for EC approval of laboratory devices. According to DIN EN ISO 12100, the term “safety of machinery” denotes the capability of a machine to fulfil its intended functions during its entire lifetime, without allowing intolerably high risks to arise in the process.

In order to fulfil safety requirements of DIN EN ISO 12100, e.g. cutting mills typically comprise a plurality of electrical, safety-related components, as follows:
1. a safe door contact,
2. a safe door tumbler,
3. a safe feedback of the door tumbler to the control device of the cutting mill,
4. a variously redundant safe standstill identification for the drive,
5. a safe momentary shutdown of the drive,
6. a safe status feedback of every safe circuit and notification means to the control device of the cutting mill,
   wherein “safe” is to be understood within the meaning of DIN EN ISO 12100.

Although laboratory mills comprising electrical or electronic safety means or motor brakes have proven themselves in principle, they can be costly and further in need of improvement with respect to possible susceptibility to errors.

The present disclosure describes and illustrates a laboratory mill which fulfils strict safety criteria, in particular with respect to access by the user to the grinder.

A further aspect of the present disclosure is that of providing a laboratory mill which is simple, cost-effective and has a low susceptibility to faults.

A further aspect of the present disclosure is that of providing a laboratory mill which has a safety means with respect to undesired user access to a grinder that is cost-effective and less susceptible to errors, and that is compact and can also be integrated into simple and small laboratory mills.

A further aspect of the present disclosure is that of providing a laboratory mill that is safe—in particular within the meaning of DIN EN ISO 12100—and which prevents or at least reduces the disadvantages described above.

The object of the present disclosure is achieved by the subject matter of the independent claims. Additional developments of the present disclosure are defined in the dependent claims.

A laboratory mill for comminuting grist is provided, which comprises a device housing having a grinder housing and/or a grinding vessel. The grinder housing or the grinding vessel defines a grinding space in the grinder housing or in the grinding vessel, in which an in particular rotating grinder is arranged or inserted, by means of which the grist is comminuted when the grinder operates. The grinder housing or the grinding vessel comprises an in particular axial user access opening, through which the user achieves access to the grinder, in the open state.

The user access opening can be closed by a grinder housing door or a safety cover, such that the grinder housing door or the safety cover defines an open and a closed state, and the user has access to the grinder through the user access opening in the open state of the grinder housing door or the safety cover, and the grinder is surrounded in a manner secured against access in the closed state, in order to operate the laboratory mill in such a way that the user reliably has no access to the grinder during operation.

The grinder is in particular configured as a rotor-grinder. The laboratory mill further comprises a motorized grinder drive for rotatably driving the grinder, e.g. with an electric motor and a drive shaft.

The grinder housing door or the safety cover comprises a closure element, by means of which the grinder housing door or the safety cover is mechanically locked in the closed state, in order to safely operate the laboratory mill.

The laboratory mill comprises a mechanical grinder drive locking means, by which the grinder drive can be mechanically blocked. The grinder drive locking means is actuated, in particular directly or indirectly, mechanically by the closure element.

The laboratory mill can in particular be configured as a cutting mill, cross beater mill, disk mill, knife mill or beater or impact mill. In the case of a cutting mill, cross beater mill or disk mill, preferably an optionally solid grinder housing is present around the rotor-grinder, and the grinder housing is closed by a grinder housing door. In this case, the closure element for the grinder housing door can also be referred to as a door closure. A knife mill or a beater or impact mill can comprise a grinding vessel, for example made of (transparent) plastics material or stainless steel, in which the grinder rotor, e.g. a rotor blade or an impact rotor, is arranged, which rotates about a vertical axis. The knife mill and the beater or impact mill can (but do not have to) additionally also comprise an encasing housing around the grinding vessel, having a closure hood. In the case of a knife mill or beater or impact mill having an additional encasing housing, the safety cover can be configured as the closure hood, and the closure element can be attached to the safety cover, configured as the closure hood, and lock this in the closed state. In the case of a knife mill or beater or impact mill which does not comprise an additional, closed encasing housing, nonetheless at least the safety cover is present, which securely closes the grinding vessel at the top. In this case, too, the closure element can be attached to the safety cover and lock this in the closed state, such that the grinding vessel is closed in a manner secured against access.

The grinder drive locking means blocks the grinder drive mechanically and in a form-fitting manner when the grinder housing door or the safety cover is not locked, and releases the grinder drive when the grinder housing door or the safety cover is locked. For this purpose, the closure element and the grinder drive locking means can be interconnected via a mechanical manipulation chain, when the grinder housing door or the safety cover is closed. Alternatively, the mechanical manipulation chain can be interrupted when the grinder housing door or the safety cover is opened. In other words, the movement of the closure element upon unlocking and locking of the grinder housing door or of the safety cover can be transmitted mechanically to the grinder drive locking means, via the closed mechanical manipulation chain, in order to lock or unlock the grinder drive locking means.

The laboratory mill can e.g. be configured as a cutting mill, cross beater mill, disk mill, knife mill or beater or impact mill, on a laboratory scale. In the case of a cutting mill or a cross beater mill, the grinder comprises one or more stationary blades and a coaxial cutting rotor that rotates within the stationary blades, preferably about a horizontal axis. A cutting mill operates according to the scissor's principle, wherein the grist is comminuted in a cutting manner between the blades of the cutting rotor and the counter-blades. A cross beater mill is constructed similarly, but has a larger gap dimension between the blades and counter-blades. In the case of a disk mill, the rotor-grinder has a rotating disk and a stationary disk, which are axially opposite one another, and wherein the grist is comminuted in the gap extending transversely between the two disks. In the case of a beater or impact mill, an impact rotor rotates about a preferably vertical axis, e.g. in an annular sieve, and comminutes the grist by the impact action of the impact rotor teeth. The rotor-grinder and the annular sieve can be arranged in a grinding vessel, which is in turn inserted into an enclosing housing. In the case of a knife mill, a rotor blade without counter-blades rotates in the grinding vessel about a vertical axis. An additional enclosing housing around the grinding vessel is possible but not essential.

A laboratory mill is in particular of a size which can e.g. be placed on a laboratory bench or can stand on feet on the laboratory floor, in a typical laboratory room.

The axial user access opening preferably serves to provide the user with access to the grinding space, axially through the user access opening, e.g. in order to remove grist or the grinder rotor from the grinding space, or to clean the grinding space, or to exchange or clean the sieve, when the grinder housing door or the closure cover is open. For this purpose, the grinder rotor can preferably be pushed onto a drive shaft with a form-fitting element, and optionally axially screwed or latched, and can optionally be removed by hand, after releasing the screw connection or latching connection.

In the case of a cutting mill, the diameter and/or the length of the laboratory mill (cutting) rotor can e.g. be in the region of some millimeters, e.g. 20 mm, to approximately 15 cm or approximately at most 20 cm. In the case of a disk mill, the diameter may optionally be larger, e.g. 15 cm to 30 cm.

In order to be able to feed the grist to the grinder during operation of the laboratory mill when the grinder housing door is closed or the safety cover is closed, the grinder housing or the safety cover may also comprise an axial or radial grist filling opening, e.g. having a filling funnel, through which the grist can be filled axially or radially into the grinding space, in order to continuously comminute the grist using the grinder, e.g. between the grinder rotor and the one or more stationary counter-elements or with the rotor blade or impact rotor. In the case of a cutting mill, the grist filling opening is in particular radial, and in the case of a cross beater mill, disk mill, knife mill or beater or impact mill it is in particular axial.

A mechanical grinder drive locking means which blocks the grinder drive mechanically in a form-fitting manner can ensure a high degree of user safety. For example, the grinder rotor, e.g. the cutting rotor, the rotating disk, the rotor blade or the impact rotor, is reliably prevented from rotating when the grinder housing door or the safety cover is open. Furthermore, possible faults of electronic safety devices cannot impair the safety of the laboratory mill with respect to undesired opening of the grinding space. Moreover, an unintended, and even an intended, incorrect operation can be effectively prevented. The mechanically actuated form-fitting blocking of the grinder drive also proves above-average safety against disallowed manipulation and in general offers a high degree of safety against injury-inducing incorrect operation or unforeseen events. In particular, safe contacts, safe tumblers or electrical status feedback means to the control device can be omitted at least in part, e.g. on variously redundant electronic safety means. Nonetheless, the safety required for the laboratory device within the meaning of DIN EN ISO 12100 or the requirement of EC approval can be fulfilled.

The grinder drive can comprise a drive motor, in particular an electric motor, and a drive shaft which is connected to the grinder in order to drive the grinder in rotation. The mechanical grinder drive locking mechanism can engage on the drive shaft and block the rotation of the drive shaft in a mechanical form-fitting manner when the grinder housing door or the safety cover is not locked. In this case, the grinder drive locking assembly can preferably be arranged between the drive motor and the grinder rotor. A direct form-fitting blocking of the drive shaft ensures a high degree of safety, e.g. against electrical malfunctions with respect to the grinder drive.

According to an embodiment, the mechanical grinder drive locking mechanism comprises a form-fitting, in particular axially form-fitting, coupling or clutch, which, in the disengaged state, releases the grinder drive for rotation, and in the engaged state blocks the grinder drive in a form-fitting manner.

The axially form-fitting coupling or clutch may comprise a stator coupling part or stator clutch part which is connected to the device housing, and a rotor coupling part or rotor clutch part which is connected to the rotating parts of the grinder drive and/or of the grinder. In the state of the stator coupling part and the rotor coupling part when engaged in a form-fitting manner, the coupling blocks the rotation of the grinder drive and/or of the grinder in a form-fitting manner.

The form-fitting coupling is preferably mechanically actuated directly or indirectly by the closure element, e.g. via the mechanical manipulation chain. In this case, e.g. in the case of a rotatable closure element, the rotational movement of the closure element can be converted into a movement which mechanically causes the engagement and disengagement of the form-fitting coupling.

The form-fitting engagement and disengagement of the form-fitting coupling can take place e.g. by axial displacement of the stator coupling part and/or of the rotor coupling part. The stator coupling part and the rotor coupling part can comprise teeth that are complementary to one another and which engage in one another in a form-fitting, in particular axial, manner when the form-fitting coupling is engaged, in order to block the rotation of the grinder in a form-fitting manner. The teeth can preferably taper in the direction of the other complementary coupling part in each case, in order to facilitate the engagement. This makes it possible to largely prevent engagement from being possible in the case of a position of the teeth where the teeth are in front of each other.

In the case of movement of the closure element for opening, in particular first the mechanical grinder drive locking mechanism locks or the form-fitting coupling is first engaged, and only after the mechanical grinder drive locking mechanism has already been locked or the form-fitting coupling has already been engaged and blocks the grinder drive in a form-fitting manner is further opening of the closure element as far as unlocking of the grinder housing door or the safety cover made possible mechanically. In other words, the unlocking of the grinder housing door or of the safety cover is mechanically blocked, and the grinder housing door or the safety cover cannot be unlocked as long as the mechanical grinder drive locking mechanism is not locked or the form-fitting coupling is not engaged. Upon movement of the closure element for closing, first the grinder housing door or the safety cover is locked, and only after the grinder housing door or the safety cover has been locked, upon further closing of the closure element, the mechanical grinder drive locking mechanism is unlocked or the form-fitting coupling disengaged, and releases the grinder drive for rotation. The unlocking of the grinder drive locking mechanism or the disengagement of the form-fitting coupling is thus mechanically not possible at least as long as the closure element has not been locked. The opening of the closure element accordingly is performed in two phases of the movement of the closure element. In a first phase, the closure element first actuates the locking of the grinder drive locking mechanism via the mechanical manipulation chain, and only thereafter, in a second phase, does the closure element unlock the grinder housing door or the safety cover. The closing of the closure element is also performed in two phases of the movement of the closure element. In a first phase, the closure element first locks the grinder housing door or the safety cover, and only thereafter, in a second phase, does the closure element actuate the unlocking of the grinder drive locking mechanism via the mechanical manipulation chain.

The movement of the closure element upon closing thus takes place in particular in temporally successive movement phases:
1. locking of the grinder housing door or of the safety cover by closing movement, e.g. rotation of the closure element in the closing direction, wherein the grinder drive locking mechanism still remains locked,
2. unlocking of the grinder drive locking mechanism in the case of continuing closing movement, e.g. rotation of the closure element in the closing direction, wherein the closure element holds the grinder housing door or the safety cover locked.

The movement of the closure element upon opening takes place in particular in temporally successive movement phases:
1. locking of the grinder drive locking mechanism by opening movement, e.g. rotation of the closure element, wherein the closure element holds the grinder housing door or the safety cover locked,
2. unlocking of the grinder housing door or of the safety cover in the case of continuing opening movement, e.g. rotation of the closure element, wherein the grinder drive locking mechanism remains locked.

In other words, the laboratory mill comprises four states, as follows:
1. The grinder housing door or the safety cover is open and the grinder drive locking mechanism is locked, such that the user has safe access to the grinder.
2. The grinder housing door or the safety cover is closed but not locked, wherein the grinder drive locking mechanism is locked.
3. The grinder housing door or the safety cover is closed and locked, but the closure element has not yet moved as far as the stop, wherein the grinder drive locking mechanism is locked.
4. The grinder housing door or the safety cover is closed, locked, and the closure element has moved as far as the stop, wherein the grinder drive locking mechanism is unlocked.

For startup, the user thus actuates the laboratory mill proceeding from the open state of the grinder housing or safety cover, and the locked state of the grinder drive locking mechanism, as follows:
1. The user closes the grinder housing door or the safety cover, wherein the grinder drive locking mechanism is locked.
2. The user moves the closure element in the closing direction and thus first locks the grinder housing door or the safety cover, wherein the grinder drive locking mechanism still remains locked.
3. The user moves the closure element further in the closing direction as far as the stop, as a result of which the unlocking of the grinder drive locking mechanism is actuated.

For opening, the user actuates the laboratory mill proceeding from the closed state of the grinder housing or of the safety cover and the unlocked state of the grinder drive locking mechanism, as follows:
1. The user moves the closure element, proceeding from the stop, in the opening direction, as a result of which first the locking of the grinder drive locking mechanism is actuated.
2. The user moves the closure element further in the opening direction and thus unlocks the grinder housing door or the safety cover, wherein the grinder drive locking mechanism, previously already locked, remains locked.
3. The user opens the grinder housing door or the safety cover, in order to achieve access to the grinder, wherein the grinder drive locking mechanism remains locked.

It is thus possible to ensure that the grinder drive is reliably mechanically blocked and can no longer perform any terminating residual rotation at the moment at which the grinder housing door or the safety cover is unlocked, and thus certainly before the grinder housing door or the safety cover can be opened. Furthermore, startup in the case of an open grinder housing door or open safety cover, e.g. in the case of an electronic malfunction, can be reliably prevented, which ensures a high safety standard.

The form-fitting coupling preferably comprises a stator coupling ring and a rotor coupling ring, which are arranged around the drive shaft. The stator coupling ring can be substantially, apart from a certain angular clearance, non-rotatably fastened to the device housing, and the drive shaft can rotate in the stator coupling ring. The rotor coupling ring can be substantially non-rotatably fastened to the drive shaft.

The form-fitting coupling can preferably be engaged in any desired rotational position of the grinder rotor, in particular without the drive motor being started up. This can be achieved e.g. in that at least one of the coupling parts, which engage in one another in a form-fitting manner, has at least so much movement clearance with respect to the other coupling part that the coupling can be engaged in a form-fitting manner, e.g. the teeth of the coupling can mesh or engage in one another in a form-fitting manner, even if the grinder rotor is jammed, e.g. by grist. The movement clearance is preferably present on both sides, such that the coupling can be completely engaged, and the grinder housing door can be opened. in any desired rotational position of the grinder rotor. For this purpose it is desirable, e.g. in the case of an axially form-fitting coupling, for the coupling to comprise a plurality of teeth and/or for the axially form-fitting coupling or at least one of the two coupling rings to have some angular clearance in both directions of rotation, specifically so much angular clearance that even in the case of a completely jammed grinder rotor the coupling teeth can nonetheless be fully inserted in any desired angular position of the grinder rotor. The movement clearance or angular clearance on both sides is preferably balanced in the disengaged state of the coupling.

The form-fitting coupling can be engaged and disengaged by axial displacement of the stator coupling ring and/or of the rotor coupling ring, in order to lock and to release the grinder drive locking mechanism.

According to an embodiment by way of example, the form-fitting coupling can comprise an axial pressure plate, which, actuated by the movement of the closure element upon movement of the closure element in the opening direction, is moved axially in order to couple the stator coupling ring and the rotor coupling ring to one another in a form-fitting manner.

As part of the mechanical manipulation chain, a mechanical manipulation device can be included, to which the closure element couples when the grinder housing door or the safety cover is closed, and which transfers the movement of the closure element, upon locking and unlocking of the grinder housing door or the safety cover, mechanically to the grinder drive locking mechanism, in order to unlock and lock this, respectively. The mechanical manipulation device can accordingly form the mechanical connecting link between the closure element and the grinder drive locking mechanism in the mechanical manipulation chain, such that the mechanical actuation of the grinder drive locking mechanism by the closure element takes place indirectly via the mechanical manipulation device.

According to an embodiment, the mechanical manipulation device still allows the stator coupling part rotational clearance to the extent that the teeth of the stator coupling part and of the rotor coupling part can nonetheless be engaged, on account of the rotational clearance, if e.g. the grinder were jammed by grist inside the grinder housing. Alternatively or in addition, the rotor coupling part could also have rotational clearance, to this small extent, with respect to the drive shaft. As a result, the engagement of the form-fitting coupling can be facilitated, while maintaining the safety features. The engagement can, furthermore, as already explained above, be facilitated by tapering teeth, e.g. having a triangular cross-section.

For coupling upon closure of the grinder housing door or of the safety cover, the closure element and the mechanical manipulation device can comprise mutually complementary coupling elements, which couple to one another upon closing of the grinder housing door or of the safety cover, and uncouple from one another upon opening of the grinder housing door or of the safety cover, such that in the coupled state, when the grinder housing door is closed or the safety cover is closed, the movement of the closure element is mechanically transmitted, via the coupled coupling elements and the mechanical manipulation device, to the grinder drive locking mechanism, in order to release the grinder drive locking mechanism upon closing of the closure element, and to lock the grinder drive locking mechanism and block the grinder drive upon opening of the closure element. As complementary coupling elements, e.g. complementary dihedra or polygons, which engage axially in a form-fitting manner when the grinder housing door or the safety cover is closed, have proven desirable. Dihedra furthermore can be coupled only in two orientations rotated about 180°.

The closure element can be configured e.g. as a key having a twist grip, which engages in a closure sleeve on the grinder housing, wherein the grinder housing door or the safety cover is locked by rotating the key in the closure sleeve. For example, the key can comprise two transverse locking bolts, which engage in the complementary closure sleeve and lock in the closure sleeve upon rotation (key-and-lock principle). In this case, it is desirable if the locking already takes place in the case of a small angle of rotation of the key, and disengagement of the form-fitting coupling begins only upon further rotation of the key during closing of the grinder housing door or the safety cover, i.e. in the case of continuous key rotation only after the key has already locked.

Accordingly, when the grinder housing door or the safety cover is closed, the key can form the mechanical manipulation chain, via the coupled coupling elements and the mechanical manipulation device with the grinder drive locking mechanism, such that a rotation of the key brings about the locking and unlocking of the grinder drive locking mechanism via the coupled coupling elements, e.g. the dihedra, and the mechanical manipulation device.

This makes it possible for simple and cost-effective, but nonetheless reliable, locking of the grinder housing door or the safety cover to be achieved, in interaction with the drive blocking.

According to one embodiment, the mechanical manipulation device can comprise a transverse slide, e.g. a transverse slide plate, wherein the actuation, e.g. rotation, of the closure element brings about a displacement of the slide plate transversely to the drive shaft. Thus, the mechanical manipulation device can be integrated in a compact manner into the drive concept of a laboratory mill, and the mechanics for bringing about the drive blocking can nonetheless be configured in a stable and thus safe manner.

According to one embodiment, the mechanical manipulation device can comprise a manipulator shaft and an eccentric. The manipulator shaft can comprise one of the two complementary coupling elements, such that the closure element or the key, comprising the other of the two complementary coupling elements, couples to the manipulator shaft in a detachable manner, when the grinder housing door or the safety cover is closed and/or the closure element or the key is inserted into the closure sleeve. In the coupled state of the complementary coupling elements, the manipulator shaft can be rotated by rotating the closure element or key, and the eccentric converts the rotational movement into a transverse displacement of the slide plate.

Furthermore, the mechanical manipulation device can comprise at least one wedge element, which converts the transverse displacement of the slide plate into an axial displacement of the form-fitting coupling, i.e. of the stator coupling part or ring and/or of the rotor coupling part or ring, e.g. via an axially movable pressure plate, which inserts the form-fitting coupling.

The safety of the laboratory mill can be achieved by the form-fitting mechanical blocking of the grinder drive. However, additional electrical or electronic protection measures can also be provided. For example, a control device and an electrically activatable holding device, e.g. in the form of an electromagnet, can be included. The control device activates the holding device when the laboratory mill is in operation, and the activated holding device holds the manipulation device, e.g. the slide plate, securely in a magnetic manner. The magnetically adhering holding prevents the closure element from being able to be moved, as long as the grinder drive is still rotating. The control device can request the rotation of the grinder drive or wait for a predetermined idle running follow-up time, and only when the control device detects that the grinder drive is no longer rotating or the idle running follow-up time has elapsed does the control device deactivate the holding device. This makes it possible to prevent the user attempting to unlock the closure element, and thus engage the form-fitting coupling, while the coupling parts are still rotating relative to one another.

Although the complete unlocking of the closure element by the mechanical manipulation chain is mechanically impossible, as long as the form-fitting coupling is not engaged, the holding device makes it possible to prevent undesired wear on the form-fitting coupling due to incorrect operation. For this reason, however, it is not necessary to configure this additional electronically controlled protection function having safety redundancy, but this also should not be excluded, however.

Upon opening of the closure element, the movement of the closure element is transferred via the mechanical manipulation device to the grinder drive locking mechanism in a mechanically rigidly coupled or positively driven manner, in order to reliably lock the grinder drive locking mechanism in that the form-fitting coupling is engaged. The movement of the closure element upon closing of the closure element is also transmitted to the grinder drive locking mechanism via the mechanical manipulation device, unlocks the grinder drive locking mechanism, and releases the form-fitting coupling for disengagement, wherein the disengagement of the form-fitting coupling can be brought about by one or more spring elements. In other words, the engagement of the form-fitting coupling can take place against a spring load. A positively driven or restraint-guided disengagement should not be excluded, however.

Thus, according to an aspect of the present disclosure, a laboratory mill in the form of a cutting mill, cross beater mill, disk mill, for comminuting grist is provided, said mill comprising the following:
a device housing comprising a grinder housing,
a grinding space in the grinding housing, wherein a grinder is arranged in the grinding housing, by means of which grinder the grist is comminuted, and wherein the grinder housing comprises a user access opening,
a grinder housing door for closing the user access opening, wherein the grinder housing door has an open and a closed state, wherein the user has access to the grinder, through the user access opening, in the open state of the grinder housing door,
a grinder drive for driving the grinder,
wherein the grinder housing door comprises a door closure, by means of which the grinder housing door can be locked, in the closed state, and
wherein the laboratory mill comprises a mechanical grinder drive locking mechanism.

According to a further aspect of the present disclosure, a laboratory mill in the form of a knife mill or beater or impact mill for comminuting grist is provided, comprising the following:
a device housing and a grinding vessel,
a grinding space in the grinding vessel, wherein a rotor-grinder comprising a grinder rotor, e.g. a rotor blade or an impact rotor, that in particular rotates about a vertical axis, can be arranged in the grinding chamber, by means of which rotor-grinder the grist is comminuted, and wherein the grinding vessel comprises an in particular upper user access opening, e.g. of the grinding vessel that is open at the top,
a safety cover, wherein the safety cover has an open and a closed state, wherein in the open state the safety cover allows the user access to the grinder rotor, in particular from above, through the user access opening,
a grinder drive for driving the grinder rotor,
wherein the safety cover comprises a closure element, by means of which the safety cover can be locked in the closed state, and
wherein the laboratory mill comprises a mechanical grinder drive locking mechanism.

The present disclosure will be explained in greater detail in the following on the basis of embodiments and with reference to the figures, wherein identical and similar elements are sometimes provided with the same reference signs, and the features of the different embodiments can be combined with one another.

### BRIEF DESCRIPTION OF THE FIGURES

In the figures:

FIG. 1 is a three-dimensional view of a cutting mill according to an embodiment of the present disclosure,

FIG. 2 shows the cutting mill from FIG. 1 with a transparent grinder housing,

FIG. 3 shows the cutting mill from FIG. 1 with an open grinder housing door,

FIG. 4 is a partially transparent three-dimensional view of the grinder housing door and the door closure of the cutting mill from FIG. 1 in a slightly open state,

FIG. 5 is a partially transparent three-dimensional view of the grinder housing of the cutting mill from FIG. 1 in a slightly open state, viewed from the motor side,

FIG. 6 is a partially transparent three-dimensional view of the grinder housing of the cutting mill from FIG. 1 in the closed state,

FIG. 7 is a partially transparent three-dimensional view showing the manipulation device in the engaged state of the form-fitting coupling, and when the grinder housing door is closed but unlocked,

FIG. 8 is an enlarged detail view of the region A in FIG. 7,

FIG. 9 is an enlarged detail view of the region B in FIG. 7,

FIG. 10 is a three-dimensional view of the manipulation device and the form-fitting coupling in the engaged state,

FIG. 11 is a rear axial view of the manipulation device in the engaged state of the form-fitting coupling,

FIG. 12 is a partially transparent three-dimensional view of the manipulation device in the case of a closed and locked grinder housing door, and in the disengaged state of the form-fitting coupling,

FIG. 13 is an enlarged detail view of the region A in FIG. 12,

FIG. 14 is an enlarged detail view of the region B in FIG. 12,

FIG. 15 is a three-dimensional view of the manipulation device and the form-fitting coupling in the disengaged state,

FIG. 16 is a rear axial view of the manipulation device in the disengaged state of the form-fitting coupling,

FIG. 17 is a longitudinal section through the cutting mill from FIG. 1,

FIG. 18 is a three-dimensional view of a knife mill according to a further embodiment of the present disclosure, having a half-opened safety cover,

FIG. 19 is an enlarged detail view of the region A in FIG. 18,

FIG. 20 as FIG. 19, but with a firmly closed safety cover,

FIG. 21 is a partially cut-away three-dimensional view of the knife mill from FIG. 18 with a closed safety cover,

FIG. 22 is an enlarged detail view of the region A in FIG. 21,

FIG. 23 is a three-dimensional view of a knife mill according to a further embodiment of the present disclosure, with a half-open safety cover,

FIG. 24 is an enlarged detail view of the region A in FIG. 23,

FIG. 25 as FIG. 23, but with a closed safety cover,

FIG. 26 is an enlarged detail view of the region A in FIG. 25,

FIG. 27 as FIG. 25 with faded out components,

FIG. 28 is an enlarged detail view of the region A in FIG. 27,

FIG. 29 is a partially transparent rear three-dimensional view of the cutting mill from FIG. 1.

### DETAILED DESCRIPTION

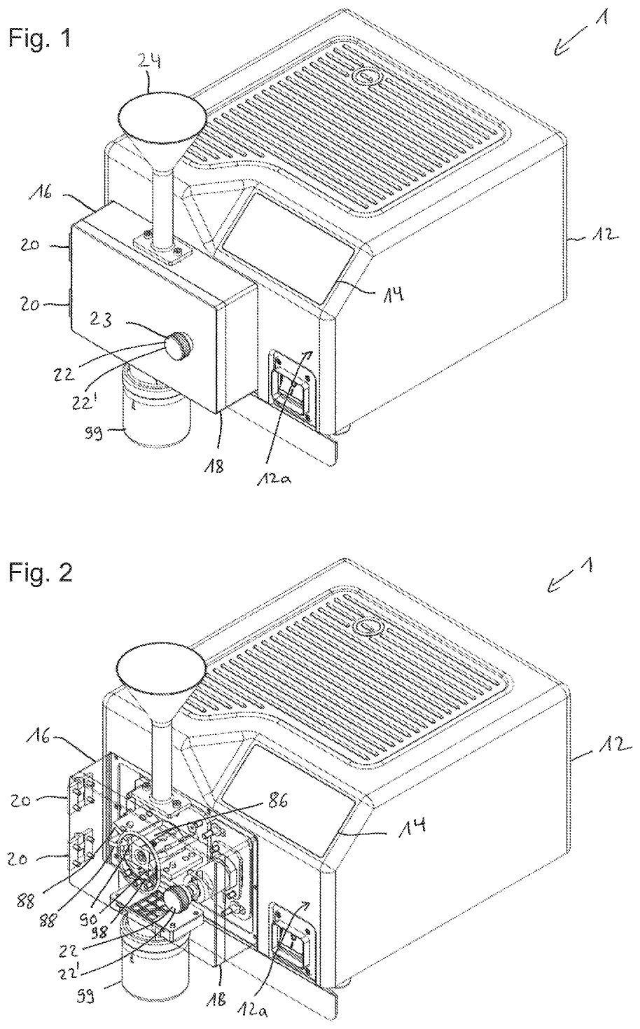

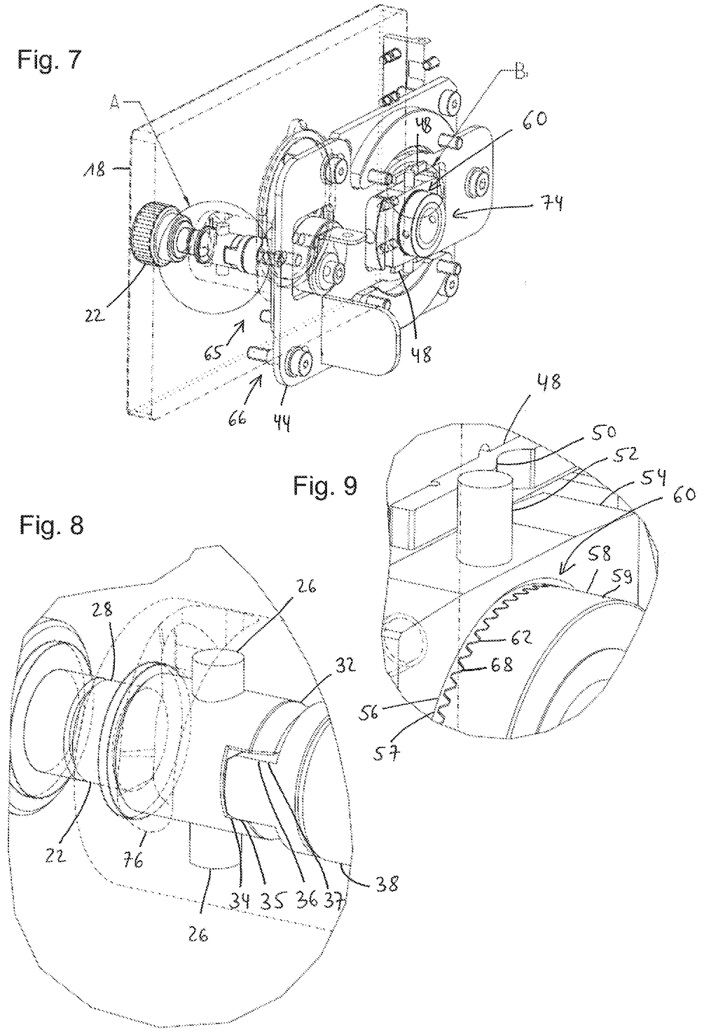

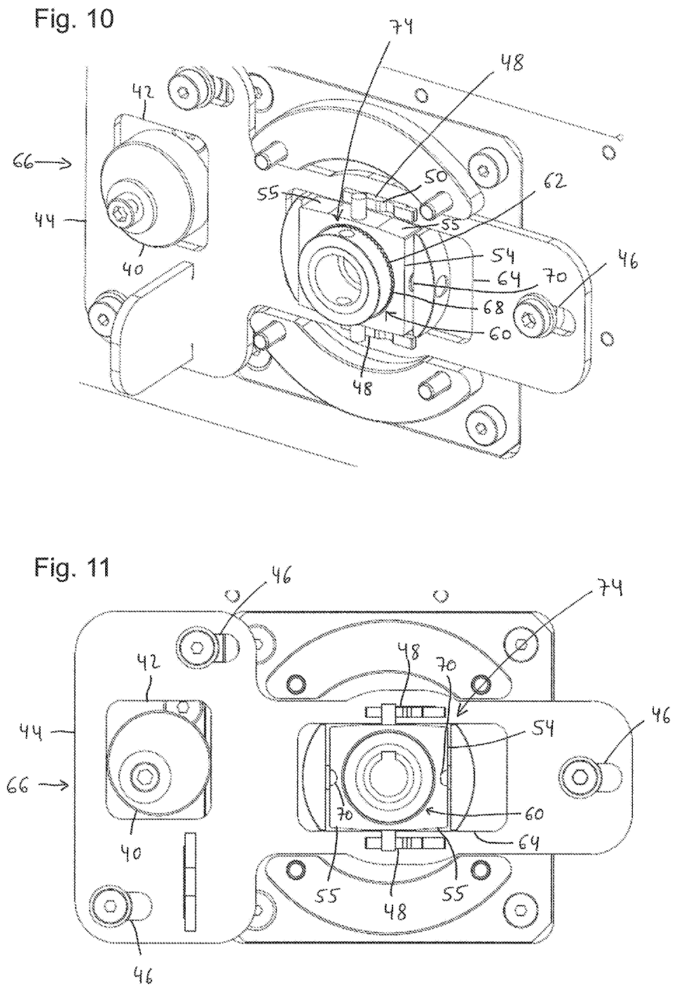

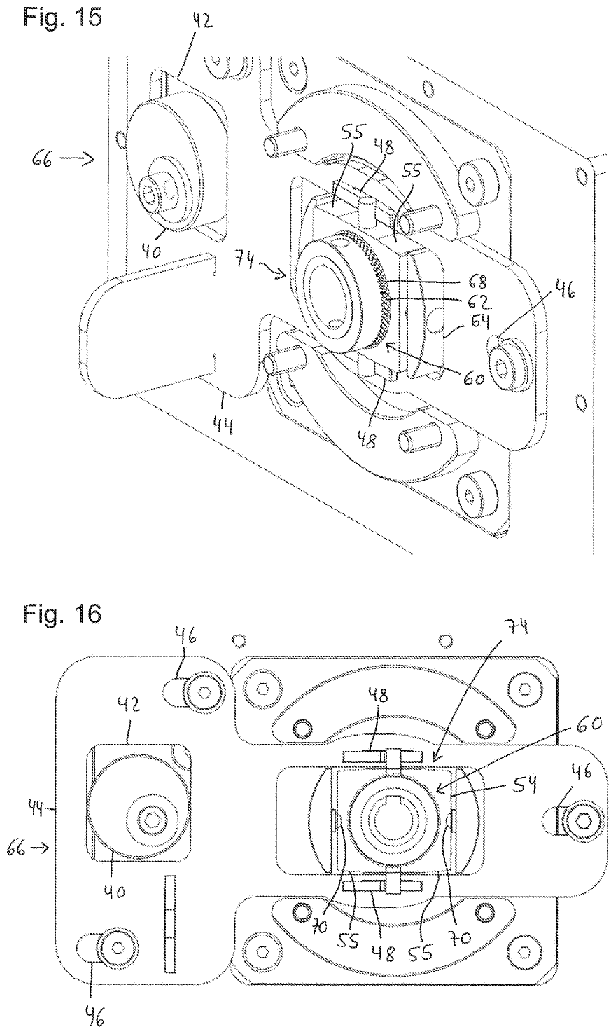

With reference to FIGS. 1-17 and 29, a laboratory mill 1, in the present example in the form of a cutting mill, is shown. The laboratory mill 1 comprises a device housing 12 having a user display 14 for inputting grinding parameters into a control device (not shown) of the laboratory mill 1 by the user. A grinder housing 16 is arranged on the front side 12a of the device housing 12, which grinder housing can be closed (axially) at the front by a safety cover in the form of a grinder housing door 18. The grinder housing door 18 is configured as a swing door and can be pivoted open and closed about hinges 20. The grinder housing door 18 can be locked with a closure element 22 in the form of a door closure 22′ when the grinder housing door 18, as shown in FIG. 1, is closed. Only when the closure element 22 is completely unlocked, the user can pivot the grinder housing door 18 open in order to achieve access to the rotor-grinder 84 which is located in the interior or grinding chamber 82 of the grinder housing 16. When the grinder housing 16 is closed, the grist can be filled in via a filling funnel 24 and a grist filling opening 25, which in this example is radial, such that grist can be continuously supplied and comminuted during operation of the cutting mill.

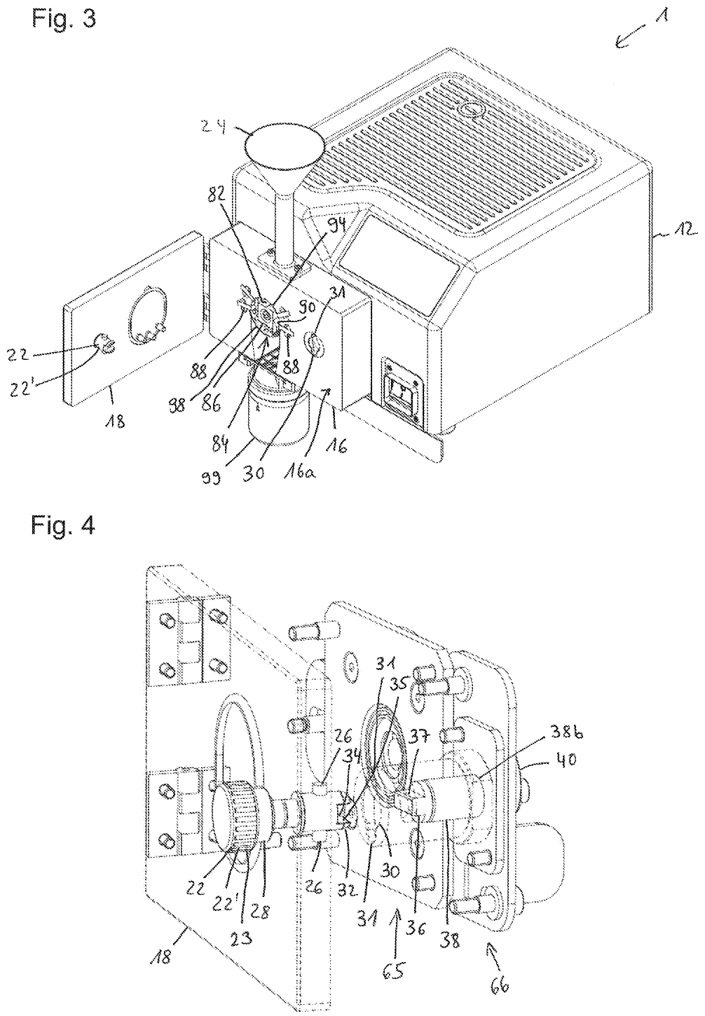

The closure element 22 comprises e.g. a twist grip 23 or rotating knob and locking bolts 26, such that a key 28 is formed. The closure element 22 or the key 28 is rotatably arranged in the grinder door 18 and can be introduced, in a suitable rotational position, into a closure sleeve 30 on the front side 16a of the grinder housing 16. The transverse extension of the locking bolts 26 means that the closure element 22 can be inserted into the closure sleeve 30 only when the closure element 22 is in the unlocking rotational position shown in FIG. 3-4. In the present example, the closure sleeve 30 is configured as a type of keyhole, and when the locking or transverse bolts 26 are vertical the closure element 22 or the key 28 can engage in the closure sleeve 30. The closure sleeve 30 comprises transverse recesses 31, in the manner of a keyhole, into which recesses the locking or transverse bolts 26 dip when the key 28 dips into the closure sleeve 30 according to the key-and-keyhole principle. By subsequent rotation of the closure element 22 with the transverse bolts 26 out of the vertical, the transverse bolts 26 lock in the closure sleeve 30 and thus lock the grinder housing door 18.

At a coupling end 32, the closure element 22 comprises a form-fitting coupling element 34. When the coupling end 32 dips into the closure sleeve 30, a form-fitting connection between the coupling element 34 and the complementary coupling element 36 of a manipulator shaft 38 results, in order to establish a form-fitting coupling between the closure element 22 and the manipulator shaft 38. In the present example, the manipulator shaft 38 is rotatably mounted in the closure sleeve 30 and the two complementary form-fitting coupling elements 34, 36 are in each case configured in the form of complementary dihedra 35, 37. When the grinder housing door 18 is closed and the closure element 22 dips into the closure sleeve 30, the two dihedra engage in one another in a form-fitting manner. If, subsequently, when the grinder housing door 18 is closed, the closure element 22 is rotated for locking, in the closure sleeve 30, the closure element 22 rotates the manipulator shaft 38 via the coupling of the two dihedra 35, 37. An eccentric disk 40 is fastened in a form-fitting manner, in a defined angular position, at the end 38b of the manipulator shaft 38 opposite the coupling element 36, e.g. screwed in a defined angular position having a mutual form-fitting connection between the manipulator shaft 38 and the eccentric disk 40.

The closure element 22, the closure sleeve 30 and the coupling elements 34, 36 are uniquely rotationally positioned relative to one another upon closure of the manipulation chain 65 by means of engagement of the coupling elements 34, 36, wherein in the present example two rotational positions of the closure element 22 are possible. In other words, the transverse recesses 31 are oriented such that in the same rotational position of the closure element 22 in which the locking bolts 26 of the closure element 22 dip into the transverse recesses 31, the two coupling elements 34, 36 also engage axially in one another. Furthermore, the closure element 22 can be locked only when it has been inserted into the closure sleeve 30 to such an extent that the two coupling elements 34, 36 have been coupled together or the manipulation chain 65 has been closed.

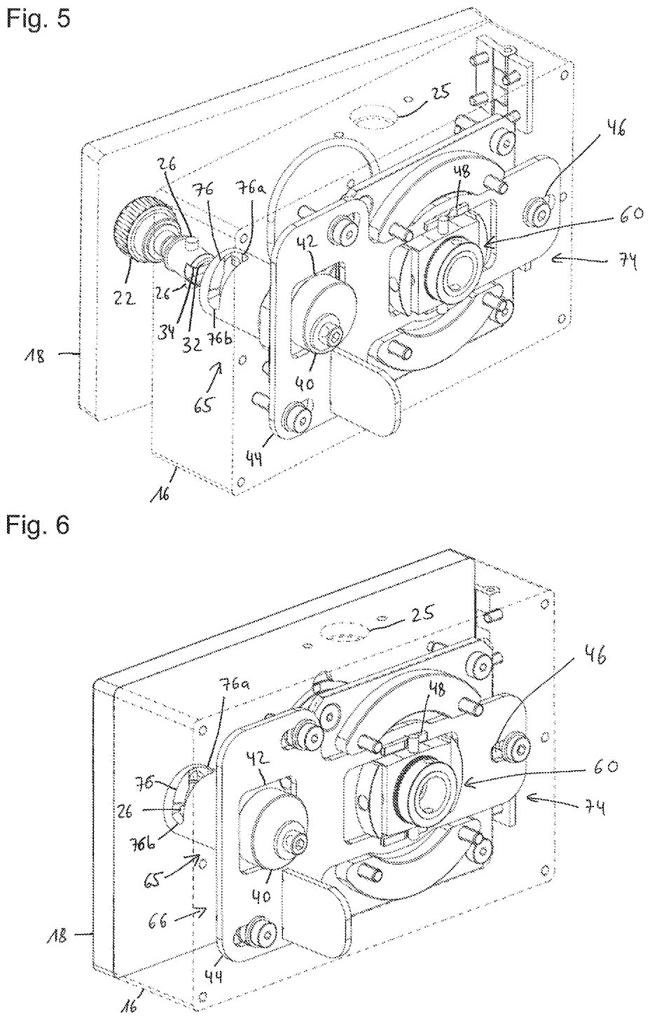

With reference to FIG. 5-16, the eccentric disk 40 is guided in an opening 42 of a transverse slide plate 44. If the closure element 22 is rotated manually by the user, the rotational movement of the closure element 22 is transmitted via the coupling elements 34, 36 to the manipulator shaft 38. As a result, the manipulator shaft 38 rotates the eccentric disk 40 in the rectangular opening 42. The slide plate 44 is guided transversely by a linear guide 46, such that the slide plate 44, driven by the eccentric disk 40, is displaced, in the present example horizontally, and specifically initially driven by the manual actuation, in this example rotation, of the closure element 22. Accordingly, the arrangement of the eccentric disk 40 in the opening 42 causes the rotational movement of the closure element 22 or of the manipulator shaft 38 to be converted into a transverse translational movement of the slide plate 44. The locking of the closure element 22 or the grinder housing door 18 thus simultaneously brings about the rotation of the manipulator shaft 38 and of the eccentric disk 40, and thus the transverse displacement of the slide plate 44.

A wedge drive 48 having oblique surfaces or lifting wedges 50 is arranged on the slide plate 44. In the case of the transverse displacement of the slide plate 44, cylinder pins of a pressure plate 54 run onto the lifting wedges 50, as a result of which the linear transverse movement of the slide plate 44 is converted into an axial displacement of the pressure plate 54 with respect to the axis of rotation X of the laboratory mill. A stator coupling part 56 in the form of a stator coupling ring 57 is fastened to the pressure plate 54, which part or ring is moved axially by the pressure plate 54. A rotor coupling part 58 in the form of a rotor coupling ring 59 is arranged axially opposite the stator coupling part 56. The two coupling parts or coupling halves 56, 58 comprise form-fitting engagement elements 62 in the form of complementary teeth 68, and form a form-fitting coupling 60. When the stator coupling part 56 is pushed axially against the rotor coupling part 58 by means of the pressure plate 54, and the complementary teeth 68 of the two coupling parts 56, 58 are brought axially into form-fitting connection, the coupling 60 is thus engaged.

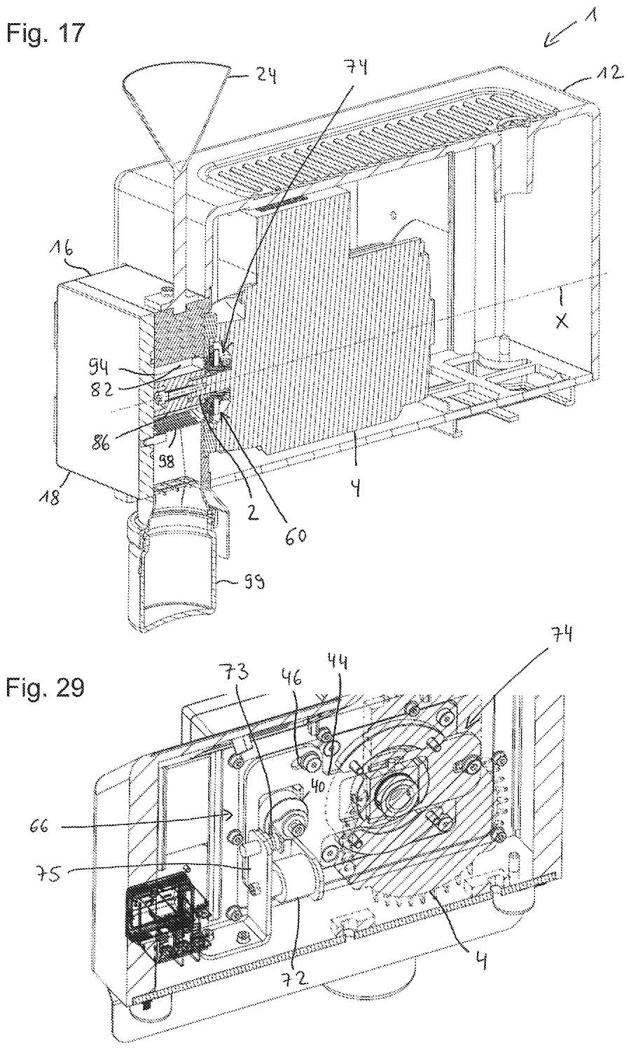

The drive shaft 2 of the drive motor 4 (FIG. 17) extends coaxially through the two coupling rings 57, 59 and defines the drive axis X. In this case, the rotor coupling ring 59 is fastened to the drive shaft by means of a form-fitting connection, i.e. rotates together with the drive shaft. The stator coupling ring 57 is fastened inside a portion 64 of the slide plate 44 on the device housing 12, by means of the pressure plate 54, so as to be non-rotatable apart from a certain angular clearance. Thus, upon axial displacement of the axial coupling ring 57 relative to the rotor coupling ring 59 a form-fitting connection results, which locks the drive shaft in a form-fitting manner against rotation. Accordingly, the two coupling parts 56, 58 form coupling halves of a form-fitting coupling 60 which locks and blocks the rotation of the drive shaft in a form-fitting manner when the coupling 60 is engaged.

The mechanical manipulation for inserting the coupling 60 accordingly takes place via a mechanical manipulation chain 65 by rotating the closure element 22, which is connected to the manipulator shaft 38 via the coupling elements 34, 36, when the closure element 22 has been introduced into the closure sleeve 30, further over the eccentric disk 40, which converts the rotational movement into a transverse displacement movement of the slide plate 44, and the wedge drive 48 with the lifting wedges 50 and the pins 52, which brings about the transverse linear displacement of the slide plate 44 into a linear axial displacement of one or both of the coupling halves or coupling parts 56, 58 of the form-fitting coupling 60, in order to engage and disengage the coupling 60. In other words, the manipulator shaft 38, the eccentric disk 40, the slide plate 44, the wedge drive 48, the lifting wedge 50 and the pressure plate 54 with the pins 52 form an example, by way of example, of a mechanical manipulation device 66, by means of which the rotational movement of the closure element 22 is mechanically transferred to the form-fitting coupling 60, in order to engage and disengage this.

In more general terms, the rotation of the closure element 22, upon unlocking and locking thereof, is converted into an axial displacement, by means of which the coupling parts 56, 58 or the coupling 60 are axially engaged and disengaged.

In the engaged state of the form-fitting coupling 60, the rotation of the drive shaft is prevented in that the pressure plate 54 is located in the rectangular cut-out 64 of the slide plate 44, and is held there in a form-fitting manner. However, the pressure plate 54 has a slight angular clearance about the drive shaft 2 in the cut-out 64, in the present example due to bevels 55, when the form-fitting coupling 60 is engaged. As a result, the reciprocal engagement of the complementary teeth 68 upon engagement of the form-fitting coupling 60 can be facilitated, since it is possible to prevent the teeth 68 from being opposite one another in a position where the teeth are in front of one another, and therefore cannot be engaged. Furthermore, the teeth 68 taper in the direction of the respectively opposite coupling ring, in order to further improve the insertion or engagement. In the present example, the teeth 68 have a triangular cross-section.

In order that, upon locking of the closure element 22, i.e. when the slide plate 44 is retracted, the pressure plate can return to the starting position with a disengaged form-fitting coupling 60 or unlocked drive shaft, the pressure plate 54 is guided via two spring pressure pieces 70, the spring-loaded balls of which engage in tapered drilled holes. The pressure pieces 70 bring about a resilient return of the pressure plate 54 into the disengaged state of the form-fitting coupling 60. Nonetheless, the pressure pieces 70 allow the slight angular twisting about the drive shaft, in order to enable the engagement of the form-fitting coupling 60, even if the grinder rotor 86 is jammed. By means of the spring pressure pieces 70, the angular clearance of the pressure plate 54 is centrally balanced in the disengaged state, such that the pressure plate 54 or more generally the form-fitting coupling 60 has enough angular clearance in both directions of rotation in order that the form-fitting coupling 60 can be engaged in any desired angular position of the drive shaft, even if the grinder rotor 86 is jammed.

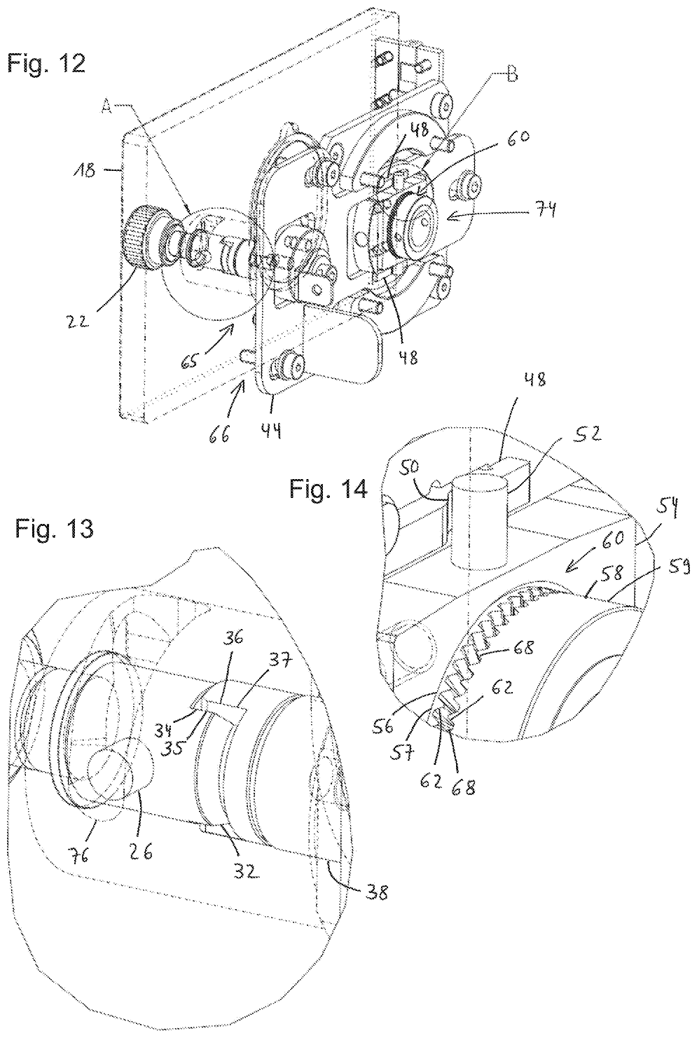

If the laboratory mill 1 is in operation, the closure element 22 is locked, the form-fitting coupling 60 is disengaged and the slide plate 44 is located in the disengaged position according to FIG. 12-16. In this state of the locked closure element 22 and the unlocked grinder drive the slide plate 44 is magnetically firmly held by an electromagnet 72.

In the control device (not shown) of the laboratory mill 1, which is typically accommodated in the device housing 12, the maximum idle running follow-up time of the drive is stored and the control device waits for this maximum idle running follow-up time before the control device deactivates the holding device, e.g. in the form of the electromagnet 72, as a result of which the movement of the mechanical manipulation chain 65 is released, such that the closure element 22 can be unlocked. Waiting for the maximum idle running follow-up time ensures that the drive has already stopped when the holding device is deactivated. As a result, a technically complex electrical standstill monitoring of the drive can be omitted. As long as the drive shaft rotates, the control device keeps the electromagnet 72 activated such that this holds the slide plate 44 firmly, in order to prevent the user from attempting to open the grinder housing cover 18 during rotation of the drive shaft. Although the unlocking of the closure element 22 from the closure sleeve 30 is in any case mechanically blocked as long as the form-fitting coupling 60 is not engaged, the magnetic holding can prevent the user from attempting to engage the form-fitting coupling 60 during rotation. Thus, undesired wear due to incorrect operation can be prevented.

Furthermore, the rotational position of the eccentric disk 40 and thus the position of the slide plate 44 or the mechanical manipulation device 66 can be queried via an electrical motor start prevention device, e.g. using a sensor or switch 73. However, this switch does not need to be a safety switch, since on account of the mechanical locking of the drive it is nonetheless not possible for injury to occur if the switch were to fail. The same applies for the magnetic holding by the electromagnet 72. The control device of the laboratory mill 1 receives a release signal from the electrical motor start prevention device, which signal releases the start of the drive motor 4 by the user. This makes it possible to prevent the user attempting to start the drive motor 4 as long as the form-fitting coupling 60 is engaged, since the motor start prevention device has not yet given a release signal and thus e.g. the frequency converter of the drive motor 4 is still reliably deactivated.

With reference to FIG. 29, the switch 73 of the motor start prevention device can e.g. be arranged as a magnetic proximity switch between the eccentric disk 40 and e.g. an angle plate 75 of the grinder housing 16 and detect the position of the mechanical manipulation device 66. The release signal for starting the motor 4 is only given if the grinder drive locking mechanism 74 is in the unlocked state.

With reference again to FIG. 5-16, the operation and function of the grinder drive locking mechanism 74, which blocks the grinder drive by means of the form-fitting coupling 60, can thus be summarized as follows. The user inserts the closure element 22 into the closure sleeve 30 and rotates the closure element 22 in the closing direction. In the process, the closure element 22 locks first, and only upon further rotation does the form-fitting coupling 60 disengage. This makes it possible to reliably prevent a state occurring in which the closure element 22 is not locked but the form-fitting coupling 60 is disengaged. Vice versa, upon opening of the closure element 22 it is ensured that first the form-fitting coupling 60 is engaged, in order to block the grinder drive, while, however, the grinder housing door 18, i.e. the transverse bolts 26 in the closure sleeve 30 are still locked. Only at the very end of the opening rotational movement of the closure element 22, after the form-fitting coupling 60 is already engaged, is the unlocked state of the closure element 22 shown in FIG. 8 reached, in which the closure element 22 can be removed from the closure sleeve 30 again, in order to pivot open the grinder housing door 18. A groove 76 turning about 90° having ends 76a, 76b in the closure sleeve 30 forms a guide for the transverse bolts 26 (FIG. 5-6). The groove 76 further has a position with which the closure element 22 and thus the grinder housing door 18 is carried along.

The mechanical manipulation device 66 comprises movement stops on both sides for the locked or unlocked state of the grinder drive locking mechanism 74, which stops are provided, in the present example, by the linear guide 46.

When the grinder housing door 18 is fully pivoted open, the user obtains axial access to the grinding space 82 and the rotor-grinder 84 arranged therein, which comprises a cutting rotor 86 that rotates coaxially to the drive axis X, and a plurality of axially extending stationary counter-blades 88 arranged annularly around the cutting rotor 86. The cutting rotor 86 is preferably plugged or pushed onto the drive shaft and screwed axially and is driven via a form-fitting element. When the grinder housing cover 18 is completely open, the user can pull the cutting rotor 86 axially from the drive shaft and pull it out axially through the axial user access opening 94. During operation, the cutting rotor 86 rotates and the grist is supplied to the rotor-grinder 84 via the filling funnel 24 through the radial grist filling opening 25 and is comminuted between the rotor blades 90 of the cutting rotor 86 and the stationary counter-blades 88 by a cutting action. Subsequently, the comminuted grist pours e.g. through a sieve 98, downwards into a collecting container 99.

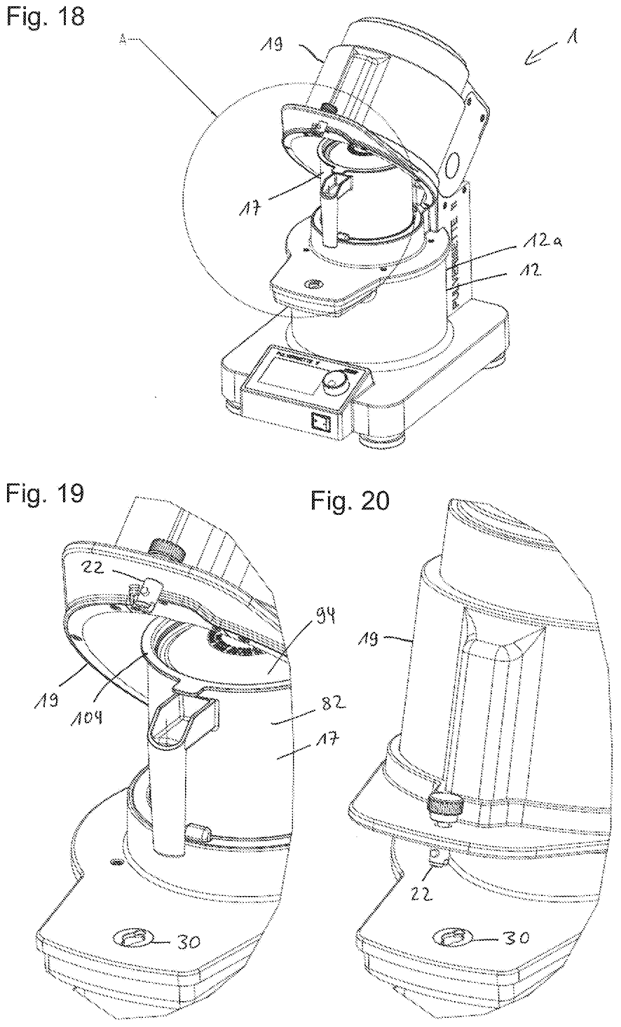

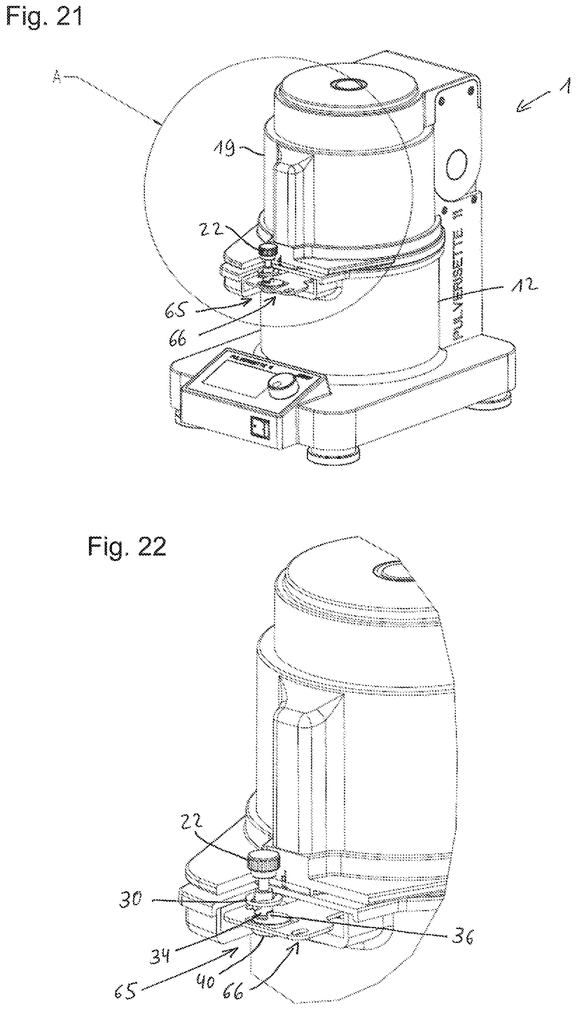

With reference to FIG. 18-22, a laboratory mill 1 in the form of a knife mill comprises a grinding vessel 17, the interior of which defines the grinding space 82 and which stands on a lower part 12a of a device housing 12. The drive motor (not shown here) is accommodated in the device housing 12 and drives, via a vertical drive shaft, a grinder rotor 86, in the form of a rotor blade (not shown), arranged in the grinding space 82 of the grinding vessel 17. Such knife mills are known in principle to a person skilled in the art (cf. PULVERISETTE® 11, www.fritsch.de).

The space around the grinding vessel 17 can be closed by the safety cover 19, in this example in the form of a pivotable safety hood, such that the grinding vessel 17 is securely accommodated by the device housing 12. The grinding vessel 17 can further comprise an inner cover 104, which, however, does not have to fulfil any safety function. Upon closing of the safety cover 19, the closure element, as in the case of the cutting mill, engages in the closure hood 30, couples to the mechanical manipulation device 66, thus closes the mechanical manipulation chain 65, is locked on the housing, and actuates the grinder drive locking mechanism 74 via the mechanical manipulation chain 65. Otherwise, the mechanical manipulation chain 65 and the grinder drive locking mechanism 74 function as in the case of the cutting mill shown in FIG. 1-17. In order to avoid repetitions, reference is made to the description there, which is hereby incorporated.

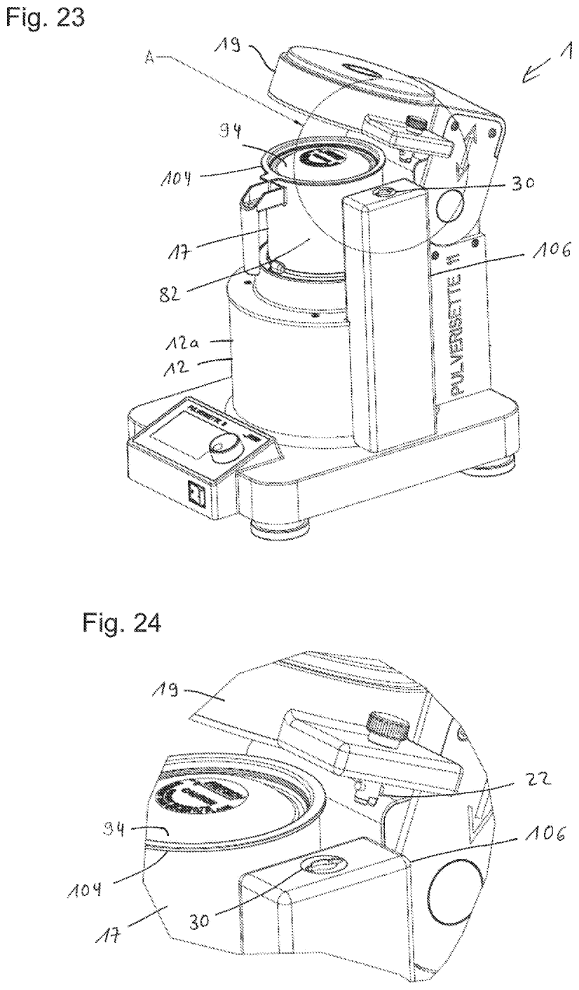

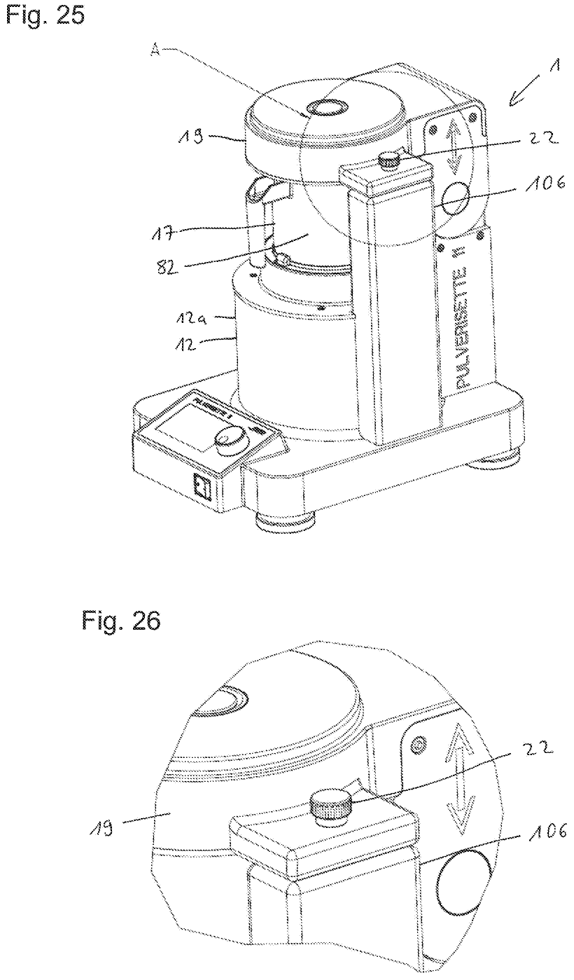

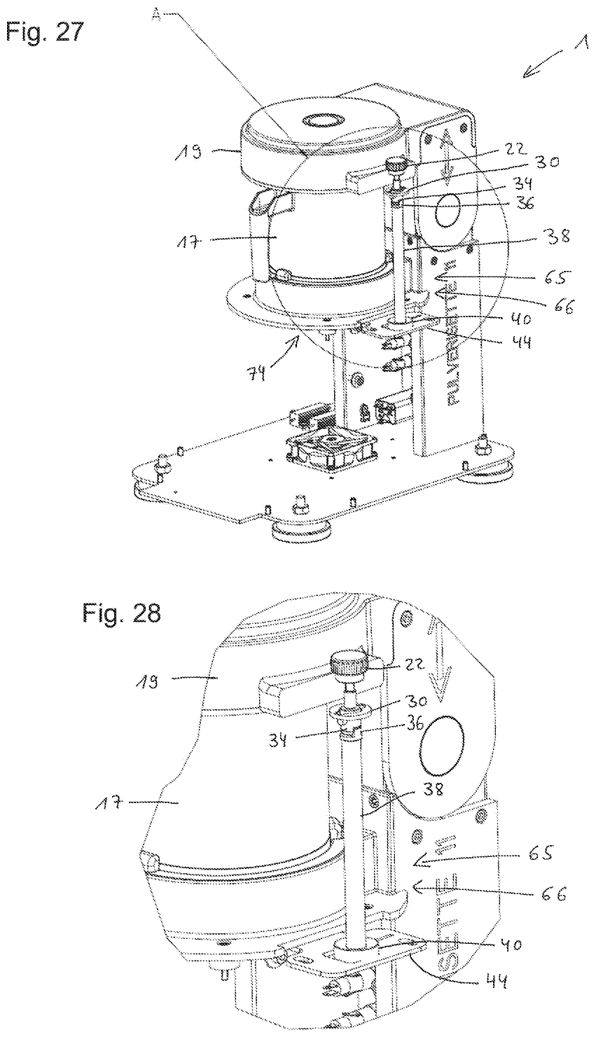

With reference to FIG. 23-28, a knife mill can also do without a safety cover 19, which does reliably close the upper opening of the grinding vessel 17 but leaves the periphery of the grinding vessel 17 free. The manipulation device 66 can for example be accommodated laterally in a tower-like housing part 106. The safety is ensured by the safety cover 19 which, as in the case of the cutting or knife mills shown in FIG. 1-22, interacts with the grinder drive locking mechanism 74. Otherwise, the mechanical manipulation chain 65 and the grinder drive locking mechanism 74 function as in the case of the cutting or knife mills shown in FIG. 1-22. In order to avoid repetitions, reference is made to the description there, which is hereby incorporated.

It is clear to a person skilled in the art that the embodiments described above are to be understood as being by way of example and the present disclosure is not limited to these, but rather can be varied in many ways without departing from the scope of protection of the claims. Corresponding components of the cutting mill and knife mill, shown by way of example, can be mutually replaced, wherein the safety cover 19 of a knife mill or beater or impact mill corresponds in functional terms to the grinder housing door 18 of a cutting mill, cross beater mill or disk mill. It is furthermore evident that the features, irrespective of whether they are disclosed in the description, the claims, the figures or elsewhere, also individually define components of the present disclosure, even if they are described together with other features.

1. A laboratory mill for comminuting grist, and configured as a cutting mill, cross beater mill, disk mill, knife mill or beater, or impact mill, comprising
a device housing having a grinder housing and/or a grinding vessel,
a grinding space in the grinder housing or in the grinding vessel, wherein a grinder can be arranged in the grinding space, by means of which grinder the grist is comminuted, and wherein the grinder housing or the grinding vessel comprises a user access opening,
a grinder housing door or a safety cover for closing the user access opening, wherein the grinder housing door or the safety cover has an open state and a closed state, wherein a user has access to the grinder through the user access opening, in the open state of the grinder housing door or of the safety cover,
a grinder drive for driving the grinder,
wherein the grinder housing door or the safety cover comprises a closure element, by means of which the grinder housing door or the safety cover can be locked in the closed state, and
wherein the laboratory mill comprises a grinder drive locking mechanism.

2. The laboratory mill according to claim 1,
wherein the grinder drive locking mechanism is actuated by the closure element and the closure element locks the mechanical grinder drive locking mechanism upon opening of the closure element, wherein the grinder drive is blocked, and/or the closure element unlocks the mechanical grinder drive locking mechanism upon closing of the closure element, wherein the grinder drive is released.

3. The laboratory mill according to claim 1,
wherein a mechanical manipulation device is included and the closure element, the mechanical manipulation device and the grinder drive locking mechanism form a mechanical manipulation chain when the grinder housing door or the safety cover is closed, and
wherein movement of the closure element is mechanically transmitted to the grinder drive locking mechanism via the mechanical manipulation chain, in order to lock and/or unlock the grinder drive locking mechanism.

4. The laboratory mill according to claim 1,
wherein upon opening of the closure element first the mechanical grinder drive locking mechanism is locked and the grinder drive is blocked, and unlocking of the grinder housing door or of the safety cover is mechanically blocked by the closure element as long as the mechanical grinder drive locking mechanism is not yet locked, and/or
wherein upon closing of the closure element firstly the grinder housing door or the safety cover is locked, and only after the grinder housing door or the safety cover has been locked, the mechanical grinder drive locking mechanism is unlocked and the grinder drive released.

5. The laboratory mill according to claim 1,
wherein the grinder drive comprises a drive motor and a drive shaft which is connected to the grinder in order to drive the grinder, and
wherein the grinder drive locking mechanism acts on the drive shaft and mechanically blocks rotation of the drive shaft when the grinder housing door or the safety cover is not locked.

6. The laboratory mill according to claim 1,
wherein the mechanical grinder drive locking mechanism comprises a form-fitting coupling which releases the grinder drive in a disengaged state and blocks the grinder drive in a form-fitting manner in an engaged state,
wherein the form-fitting coupling in particular comprises a stator coupling part which is connected to the device housing, and a rotor coupling part which is connected to rotating parts of the grinder drive and/or of the grinder, and
wherein, in a form-fitting engaged state, the stator coupling part and the rotor coupling part block rotation of the grinder in a form-fitting manner.

7. The laboratory mill according to claim 6,
wherein the form-fitting coupling is engaged and disengaged by axial displacement of the stator coupling part and/or of the rotor coupling part, in order to lock and unlock the grinder drive locking mechanism.

8. The laboratory mill according to claim 6,
wherein the form-fitting coupling comprises a stator coupling ring and a rotor coupling ring which are arranged around a drive shaft, wherein the stator coupling ring is fastened to the device housing and the drive shaft rotates in the stator coupling ring in the disengaged state of the coupling, and wherein the rotor coupling ring is fastened to the drive shaft.

9. The laboratory mill according to claim 1,
wherein a mechanical manipulation device is included, to which the closure element couples when the grinder housing door or the safety cover is closed, and which mechanically transmits movement of the closure element, upon locking and unlocking of the grinder housing door or the safety cover, to the grinder drive locking mechanism.

10. The laboratory mill according to claim 9,
wherein the closure element and the mechanical manipulation device comprise mutually complementary coupling elements which couple to one another upon closing of the grinder housing door or of the safety cover and/or uncouple from one another upon opening of the grinder housing door or of the safety cover, wherein in a coupled state, movement of the closure element is mechanically transmitted to the grinder drive locking mechanism via the coupled coupling elements and the mechanical manipulation device, in order to unlock the grinder drive locking mechanism upon closing of the closure element and to release the grinder drive, and/or to lock the grinder drive locking mechanism upon opening of the closure element and to block the grinder drive.

11. The laboratory mill according to claim 1,
wherein the closure element comprises a key which engages in a closure sleeve and locks and unlocks the grinder housing door or the safety cover, and actuates the unlocking and locking of the grinder drive locking mechanism, by rotation of the key in the closure sleeve.

12. The laboratory mill according to claim 1,
wherein a transverse slide is included and actuation of the closure element effects a transverse displacement of the transverse slide.

13. The laboratory mill according to claim 12,
wherein a mechanical manipulation device comprises a manipulator shaft and an eccentric that is connected to the manipulator shaft, wherein the manipulator shaft is rotated by the closure element and the eccentric converts rotational movement of the manipulator shaft into a transverse displacement of the transverse slide.

14. The laboratory mill according to claim 13,
wherein a control device and an electrically activatable holding device are included, and the control device activates the holding device when the laboratory mill is in operation, wherein the activatable holding device firmly holds the mechanical manipulation device and prevents, by firm holding, the closure element from being able to be moved, and/or wherein the control device deactivates the holding device when the grinder drive is stationary.

15. The laboratory mill according to claim 13,
wherein movement of the closure element when opening the closure element is transmitted to the grinder drive locking mechanism by rigid mechanical coupling via the mechanical manipulation device, in order to engage the form-fitting coupling and to lock the grinder drive locking mechanism, and/or
wherein movement of the closure element when closing the closure element is transmitted to the grinder drive locking mechanism via the mechanical manipulation device, in order to unlock the mechanical grinder drive locking mechanism, and wherein disengagement of the form-fitting coupling is effected by spring force.

16. A laboratory mill for comminuting grist, and configured as a cutting mill, cross beater mill or disk mill, and comprising
a device housing having a grinder housing,
a grinding space in the grinder housing, wherein a grinder can be arranged in the grinding space, by means of which grinder the grist is comminuted, and wherein the grinder housing comprises a user access opening,
a grinder housing door for closing the user access opening, wherein the grinder housing door has an open and a closed state, wherein a user has access to the grinder in the open state of the grinder housing door, through the user access opening,
a grinder drive for driving the grinder, and
wherein the grinder housing door comprises a door closure, by means of which the grinder housing door can be locked in the closed state and wherein the laboratory mill comprises a mechanical grinder drive locking mechanism.

17. A laboratory mill for comminuting grist, and configured as a knife mill or beater or impact mill, and comprising
a device housing and a grinding vessel,
a grinding space in the grinding vessel, wherein a grinder comprising a grinder rotor can be arranged in the grinding space, by means of which grinder the grist is comminuted, and wherein the grinding vessel comprises a user access opening,
a safety cover, wherein the safety cover has an open and a closed state, wherein the safety cover allows the user access to the grinder rotor through the user access opening in the open state,
a grinder drive for driving the grinder rotor,
wherein the safety cover comprises a closure element by means of which the safety cover can be locked in the closed state, and
wherein the laboratory mill comprises a mechanical grinder drive locking mechanism.
